(19) United States
(12) Patent Application Publication
(10) Pub. No.: US 2021/0103887 A1
(43) Pub. Date: Apr. 8, 2021

(54) DETERMINING DELIVERY TIMES BASED ON DELIVERY ADDRESS

(71) Applicant: Capital One Services, LLC, McLean, VA (US)

(72) Inventors: Jeremy PHILLIPS, Brooklyn, NY (US); Maxime MOISE, Brooklyn, NY (US)

(73) Assignee: Capital One Services, LLC, McLean, VA (US)

(21) Appl. No.: 16/595,675

(22) Filed: Oct. 8, 2019

(51) Int. Cl. G06Q 10/08

(52) U.S. Cl. CPC G06Q 10/0833; G06Q 10/0836; G06Q 10/0834; G06Q 10/0832

(57) ABSTRACT

Systems, methods, apparatuses, and computer program products to determine delivery times based on a delivery address. A request may be from an application executing on a mobile device specifying a delivery address for delivery of an item. A plurality of delivery times may be received from a plurality of delivery services, the plurality of delivery times based on a time at the delivery address. Selection of a first delivery time may be received from the application. A pickup location and a pickup time may be determined. A request to deliver the item to the delivery address may be transmitted to a first delivery service. Acceptance of the request may be received from the first delivery service. A confirmation may be transmitted to the application. An indication of the order may be stored in a database.

### TECHNICAL FIELD

Embodiments disclosed herein generally relate to computing services. More specifically, embodiments disclosed herein relate to computing services that determine delivery times based on a delivery address.

### BACKGROUND

Users often use computing devices to place orders for items to be delivered at a delivery address. Often, the user is allowed to specify a time for the delivery. However, for any number of reasons, the time at the delivery address may be different than the time specified by the user. Therefore, the user may inadvertently select an incorrect delivery time (e.g., a delivery time that is later than the intended time) and/or an impossible delivery time (e.g., a delivery time that is in the past).

### SUMMARY

Embodiments disclosed herein provide systems, methods, articles of manufacture, and computer-readable media for determining delivery times based on a delivery address. In one example, a request may be received from an application executing on a mobile device specifying a delivery address for delivery of an item. A plurality of delivery times for delivery of the item may be received from a plurality of delivery services, the plurality of delivery times based on a time at the delivery address, the time at the delivery address different than a time of the mobile device. The plurality of delivery times for the delivery may be transmitted to the application executing on the mobile device. Selection of a first delivery time of the plurality of delivery times may be received. A pickup location and a pickup time for the item may be determined based on the delivery address and the first delivery time. An indication of the item and the pickup time may be transmitted to a device associated with the pickup location. Confirmation that the item will be available for pickup at the pickup location at the pickup time may be received from the device associated with the pickup location. A request to deliver the item to the delivery address may be transmitted to a first delivery service of the plurality of delivery services, the request further specifying the pickup location and the pickup time for the item, the first delivery service associated with the selected first delivery time. Acceptance of the request to deliver the item to the delivery address may be received from the first delivery service. A confirmation indicating that the item was ordered for delivery to the delivery address by the first delivery service at the first delivery time may be transmitted to the application executing on the mobile device. An indication may be stored in a database, the stored indication specifying that the item was ordered for delivery to the delivery address by the first delivery service at the first delivery time, the stored indication further specifying an account associated with the mobile device.

### BRIEF DESCRIPTION OF THE DRAWINGS

FIG. 1 illustrates an embodiment of a system that determines delivery times based on a delivery address.

FIGS. 2A-2E illustrate embodiments of determining delivery times based on a delivery address.

FIG. 3 illustrates an embodiment of a first logic flow.

FIG. 4 illustrates an embodiment of a second logic flow.

FIG. 5 illustrates an embodiment of a third logic flow.

FIG. 6 illustrates an embodiment of a fourth logic flow.

FIG. 7 illustrates an embodiment of a computing architecture.

### DETAILED DESCRIPTION

Embodiments disclosed herein provide techniques to determine delivery times based on a delivery address associated with an order. Generally, a user of a computing device may use an application to specify one or more items and/or services to be purchased. As part of the checkout process, embodiments disclosed herein may require that the user specify a delivery address where the items are to be delivered (and/or the services are to be provided and/or initiated) before displaying one or more available delivery times to the user. However, the current time at the delivery address may be different than a system time of the user's computing device.

Advantageously, when the user provides the delivery address to the application, the application may transmit the delivery address via one or more application programming interfaces (APIs) over a developer exchange. An orchestration layer associated with the application may receive the current time at the delivery address from a network time service via the APIs. For example, the time at the delivery address may be based on a time zone of the delivery address and/or whether daylight savings time is currently observed at the delivery address. The orchestration layer may provide the delivery address and the determined time at the delivery address to a plurality of delivery services via the APIs. The delivery services may then transmit a plurality of delivery time options to the orchestration layer via the APIs. These orchestration layer may provide the received delivery times to the computing device, where the application may output the delivery times to the user.

The user may then select a first delivery time. The application may transmit an indication of the first delivery time (and the delivery service associated with the first delivery time) to the orchestration layer via the APIs. In examples where an item is ordered, the orchestration layer may then transmit instructions to prepare the item for pickup at a pickup location. For example, if the item is a payment card, the orchestration layer may instruct a branch of a bank to prepare the payment card for pickup by the delivery service. The orchestration layer may then transmit instructions to the delivery service. The instructions may comprise a request to pick up the item at the pickup location at a pickup time and deliver the item to the delivery address at the first delivery time selected by the user. The orchestration layer may then transmit an order confirmation to the user and store an indication of the order of the item in a database. The user may then use the application to receive status updates regarding the order.

Advantageously, embodiments disclosed herein provide techniques to improve order processing and delivery orchestration when computing devices are used to place orders. For example, a user can easily modify the time on their computing device, which, when received by an order processing system, may result in the scheduling of incorrect delivery times. As another example, the actual time where the computing device is located may be different than the time at the delivery address (e.g., based on time zone differences, daylight savings time differences, etc.). By leveraging a trusted network time service to ensure that the correct delivery times are selected, embodiments disclosed herein overcome the drawbacks to conventional solutions, which only consider the time of the device and not the time at the delivery address. Doing so reduces delivery costs and/or improves service. Furthermore, by selecting pickup locations and/or delivery services that can meet any security requirements associated with the item, embodiments disclosed herein improve the security of the item during all phases of order processing, including item preparation, pickup, and/or delivery.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

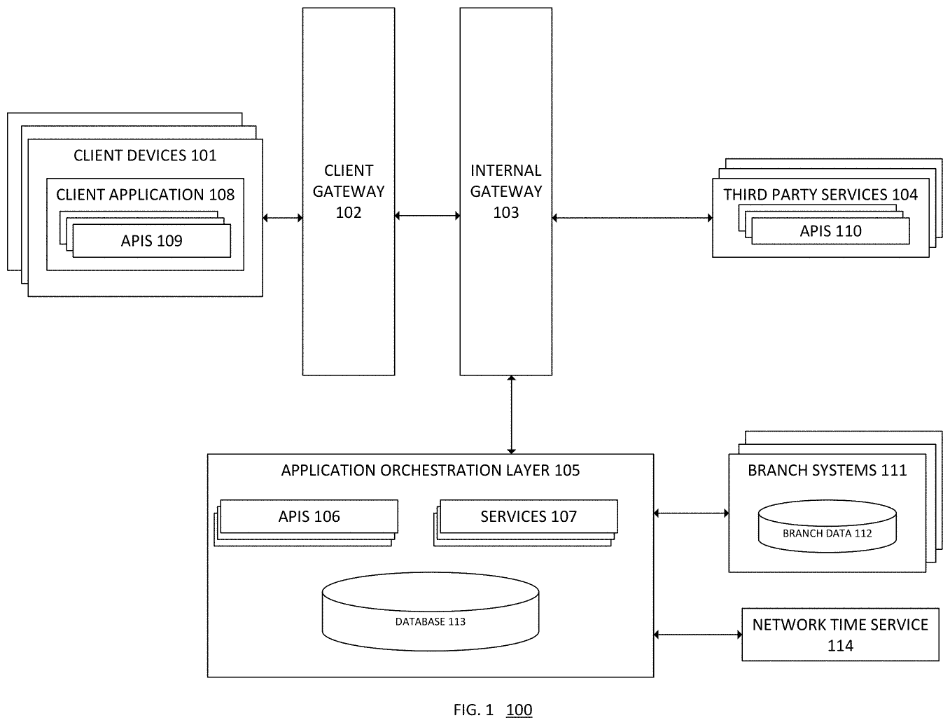

FIG. 1 depicts an exemplary system 100, consistent with disclosed embodiments. As shown, the system 100 includes one or more client devices 101, client gateway 102, internal gateway 103, one or more third party services 104, an application orchestration layer (OL) 105, one or more branch systems 111, and a network time service 114.

The client devices 101 are representative of any type of computing system, such as smartphones, tablet computers, wearable devices, laptop computers, portable gaming devices, and the like. The client devices 101 further include processor, a memory, network interface, and/or other components not pictured for the sake of clarity. The client devices 101 include an instance of one or more client applications 108. The client application 108 is representative of any type of application configured to place an order. The order may be for any type of item and/or service. For example, the client application 108 may be an application provided by a financial institution to place orders related to one or more accounts held by a user at the financial institution (e.g., to order a replacement payment card (e.g., a debit card, a credit card, or a pre-paid card), secure documents, loan documents, a book of checks, and cash). As another example, the client application 108 may be an application used to purchase items and/or services, such as taxi/car services, food from restaurants or other food service locations, grocery purchases, etc. As described in greater detail below, the order may be associated with a delivery address provided by the user. However, a time at the delivery address may be different than a time of the client device 101. The different times may be due to any factor, such as the client device 101 having a user-modified system time, the client device 101 being in a different time zone than the delivery address and therefore having a different system time, the client device 101 being in the same time zone as the delivery address but where daylight savings time observations differ, etc. Advantageously, the system 100 is configured to ensure that any delivery times for the order are based on the time at the delivery address.

The client gateway 102, internal gateway 103, third party services 104, application OL 105, branch systems 111, and network time services 114 are representative of software, hardware, and/or a combination of software and hardware. More generally, the gateway 102, internal gateway 103, third party services 104, application OL 105, branch systems 111, and network time services 114 are representative of any type of physical and/or virtualized computing system (and/or software executing on a physical and/or virtualized computing system). For example, such a physical computing system may be a server, workstation, compute cluster, compute node, or any other computing device including a processor, a memory, network interface, and/or other components not pictured for the sake of clarity. More generally, the configuration depicted in FIG. 1 should not be considered limiting of the disclosure, as the disclosure is applicable to any type of configuration.

The client gateway 102 is a gateway service that provides a layer of security between the client devices 101 and the other components of the system 100. Similarly, the internal gateway 103 provides a layer of security between the application OL 105 and at least the third party services 104 and/or the client devices 101. More generally, the gateways 102, 103 may provide dynamic routing, monitoring, resiliency, and security in the system 100. Therefore, communications between the client devices 101 and the remaining components of the system 100 may pass through the secure interface of the client gateway 102. Similarly, communications between the application OL 105 and at least the third party services 104 may pass through the secure interface of the internal gateway 103.

As shown, the application OL 105 may generally include one or more of the APIs 106 and one or more services 107. The APIs 106 may generally include any number and type of APIs. Although the APIs 106 are depicted as being separate from the APIs 109 of the client application 108 and/or the APIs 110 of the third party services 104, any configuration of APIs is contemplated by the disclosure, and the particular configuration depicted in FIG. 1 should not be considered limiting of the disclosure. The services 107 and network time service 114 are representative of any type of any type of computing service and/or microservice. Although depicted as a separate service, in one embodiment, the network time service 114 is one of the services 107. The network time service 114 generally returns a time corresponding to an address received as input (e.g., a delivery address provided by the application OL 105).

The APIs 106, 109 and the services 107, 114 may be provided through a developer exchange (not pictured). The developer exchange may provide a common software architecture where internal or external services, microservices, and/or APIs are stored. In such an example, the APIs 106, 109 may be considered to be “internal” APIs, while the third party APIs 110 may be considered to be “external” APIs.

Collectively, the services 107 may leverage the APIs 106 of the application OL 105 to interact with the APIs 109 of the client application 108 and/or the APIs 110 of the third party services 104 to provide to allow a user of a client device 101 to place an order for an item and/or service to be delivered at a delivery address and schedule the delivery based on a time at the delivery address (which may be different than the time of the client device 101). As stated, the use of APIs and/or services as a reference example of a programming paradigm herein should not be considered limiting of the disclosure, as the techniques of the disclosure are equally applicable to any type of programming paradigm. Furthermore, the functionality described herein may be performed using an API, a service, and/or a combination of APIs and services.

Generally, a user of the client application 108 may desire to order an item to be delivered. The use of an item (or any particular item) herein as an example subject of an order to should not be considered limiting of the disclosure, as the disclosure is equally applicable to any type of order (e.g., for services, foods, goods, products, etc.). For example, the user's payment card may not operate properly and/or may be lost and/or stolen. As such, the user may provide authentication credentials (e.g., login/password, biometric credentials, etc.) for their account with the issuing financial institution in the client application 108. Once authenticated, the client application 108 may provide one or more graphical user interfaces (GUIs) that allow the user to place the order for delivery of a replacement card.

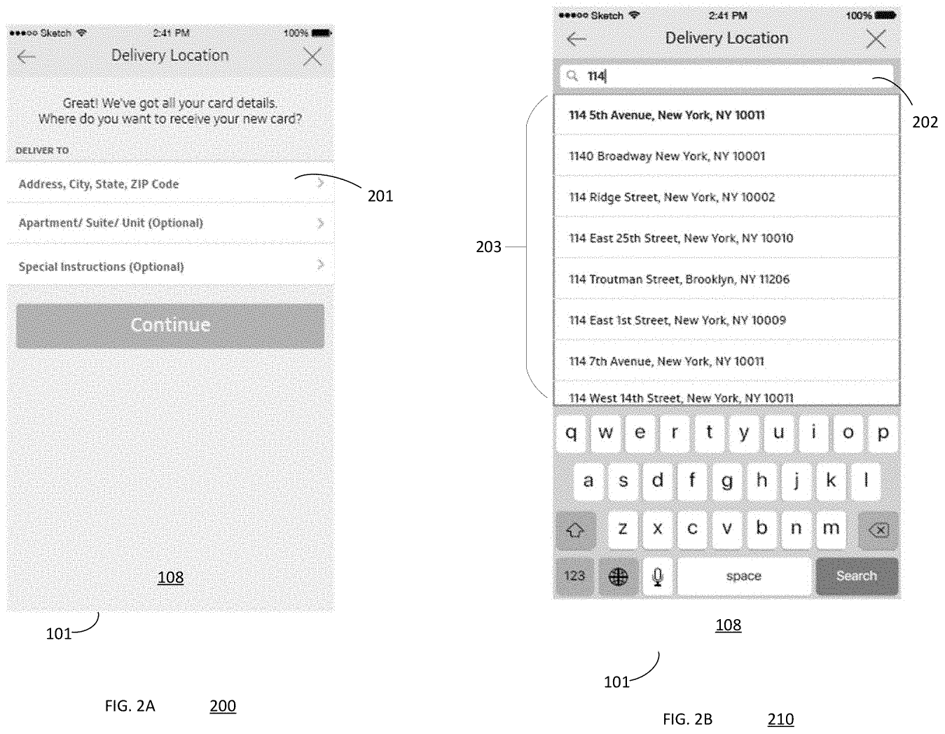

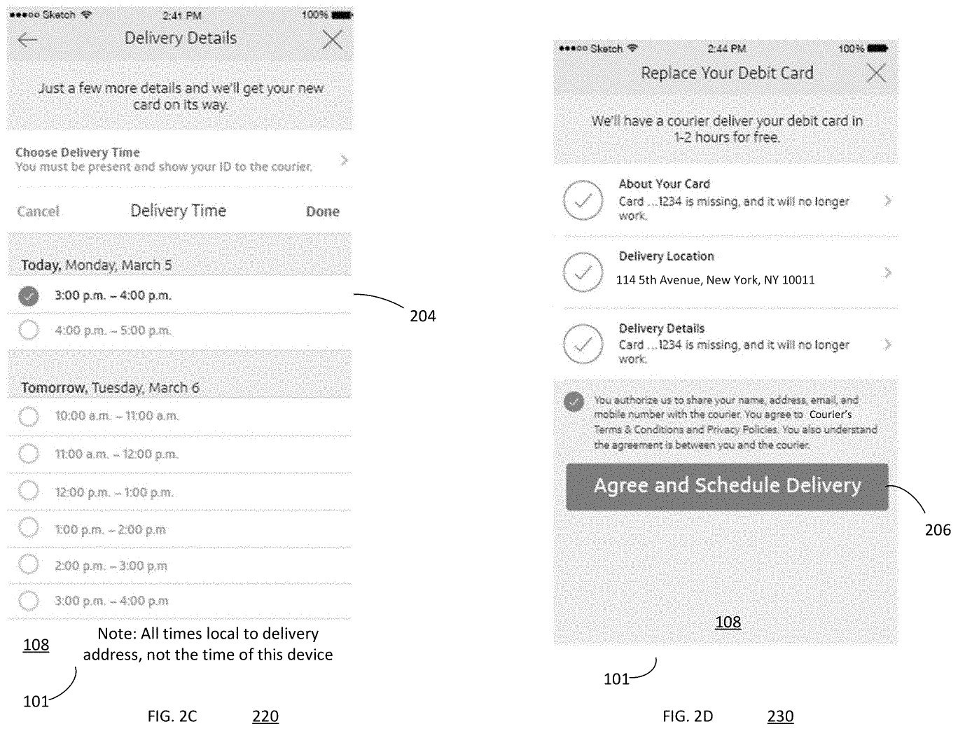

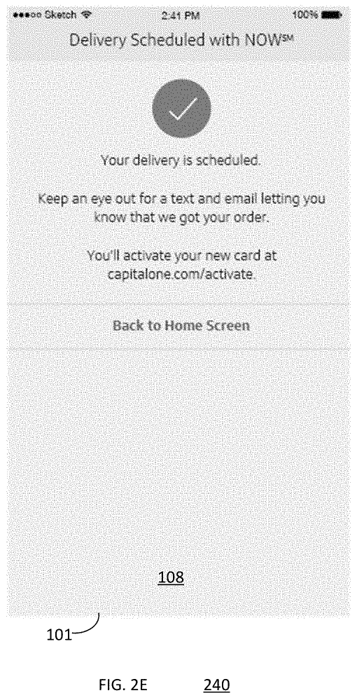

FIG. 2A is a schematic 200 illustrating an embodiment of a GUI provided by the client application 108 on the client device 101. As shown, the client application 108 indicates, to the user, that a delivery address is required to order for a replacement payment card. The user may then select GUI element 201 to provide the delivery address. Doing so may cause the client application 108 to output an address field 202 as depicted in the schematic 210 of FIG. 2B. As the user enters data into the address field 202, an API 109 of the client application 108 may transmit the entered data (e.g., “114” in FIG. 2B) to an API 106 of the application OL 105 (and/or an API 110 of the third party services 104). The application OL 105 may then make an API call to an autocomplete API 110 of a third party service 104 that provides address suggestions based on the data entered by the user (e.g., “114). The autocomplete API 110 may then return a plurality of suggested addresses to the application OL 105 that correspond to the data entered by the user. The application OL 105 may then transmit the suggested addresses to the client application 108. However, as stated, the autocomplete APIs 110 of the third party services 104 may transmit the suggested addresses directly to the client application 108 without the application OL 105 serving as an intermediary.

As shown in FIG. 2B, the client application 108 outputs the suggested addresses 203 received from the application OL 105. Doing so may allow the user to select the correct delivery address, if depicted, for autofilling (or autocompleting) in the address field 202. Additionally and/or alternatively, the user may continue providing input data to the address field 202. For the purpose of illustration, and not limitation, the user may select one of the suggested addresses 203 as the delivery address for the payment card. For example, the selected delivery address may be “114 5^{th} Avenue, New York, N.Y., 10011.” Once selected, the client application 108 may transmit the selected delivery address via one or more of the APIs 109 to the APIs 106 of the application OL 105. Furthermore, the one or more APIs 109 of the client application 108 may send a time of the client device 101 to the APIs 106 of the application OL 105. The application OL 105 may store the received time of the client device 101 for later use.

Once the delivery address is received, the application OL 105 may provide the selected delivery address to the network time service 114 to receive a time at the selected delivery address from the network time service 114. In some embodiments, the time returned by the network time service 114 may be a coordinated universal time (UTC) time. In such embodiments, the time returned by the network time service 114 may be modified by an offset corresponding to a time zone of the selected delivery address to determine the actual time at the delivery address. The offset may further be based on other factors, such as whether the delivery address is observing daylight savings time. In other embodiments, the network time service 114 determines the offset and applies the offset before transmitting the time at the delivery address to the APIs 106 of the application OL 105. The application OL 105 may generally store the time at the delivery address for later use.

The application OL 105 may then transmit, by one or more services 107 via one or more APIs 106, the selected delivery address and the time at the delivery address to one or more APIs 110 of the third party services 104 as part of a request to provide available times to deliver the item to the delivery address. For example, one or more of the third party services 104 may be provided by a courier and/or delivery service (collectively referred to herein as “delivery services”). The third party delivery services 104 may then determine a plurality of available delivery times for the delivery address and return the available delivery times to the application OL 105. In some embodiments, the third party delivery services 104 may further provide an estimated cost of the delivery services. Further still, the third party delivery services 104 may provide an earliest available pickup time that the service can pick up the item to be delivered, where the earliest available pickup time corresponds to a delivery time at the delivery address.

In some embodiments, the application OL 105 may determine whether an attribute of the item to be ordered has one or more security requirements. For example, an attribute of the payment card specified in the database 113 may specify that the payment card must be picked up at a secure location, delivered in a secure box, transported in a secure vehicle, and requires a signature to be delivered. Therefore, the request for available delivery times sent by the APIs 106 and/or the services 107 of the application OL 105 may specify an indication of the attribute. Doing so may allow the third party delivery services 104 to determine whether these security requirements can be fulfilled and provide an indication of whether the security requirements can be fulfilled to the application OL 105.

The application OL 105 may then transmit the received available delivery times to the client device 101 (e.g., via the APIs 106). FIG. 2C is a schematic 220 depicting an embodiment where the client application 108 outputs the available delivery times for display on the device 101. As shown, the GUI of the client application 108 indicates that the displayed times correspond to times at the delivery address, which may be different than the time of the device (and/or a time at the device's location). The user may select a delivery time 204, which in the depicted example, corresponds to a 1-hour window from 3-4 PM on Monday, March 5.

FIG. 2D is a schematic 230 depicting the client application 108 displaying an order submission GUI responsive to the selection of delivery time 204 in FIG. 2C. As shown, the client application 108 displays order details and a GUI button 206 used to submit the order. In response to the selection of the GUI button 206, the APIs 109 of the client application 108 may transmit an indication of the selected time 204 to the APIs 106 and/or the services 107 of the application OL 105.

Responsive to receiving the selected time 204, the application OL 105 may process the order for the payment card to be delivered at the selected time 204. More specifically, the application OL 105 may transmit a respective request to each of a plurality of branch systems 111. Each branch system 111 may correspond to one or more physical locations where an item to be delivered by a delivery service may be picked up (by the delivery service and/or the customer). For example, each branch system 111 may correspond to a physical location of the financial institution (e.g., a bank branch). As another example, a given branch system 111 may correspond to one or more restaurants preparing food to be picked up by the delivery service for delivery to the delivery address. As additional examples, the items may be picked up at a warehouse, third-party location, a retail store, etc. In such examples, the application OL 105 may transmit the request to the third party service 104, which may return one or more physical locations where the item can be picked up consistent with disclosed embodiments.

Continuing with the payment card example, the request may specify to prepare the payment card by a pickup time, where the pickup time corresponds to a time (local to the branch) that the payment card is to be ready for pickup by a delivery service. The branch systems 111 may reference the branch data 112 to determine whether the request can be fulfilled by the branch, e.g., based on branch operating hours, whether payment cards are available at the branch, the earliest available pickup time specified by the delivery service for the corresponding delivery time, current staffing at the branch, staff availability at the branch, branch proximity to the delivery address and/or the delivery services, whether the branch can fulfill security requirements (e.g., provide secure packaging for the payment card), etc. The branch systems 111 may then transmit a reply to the application OL 105 indicating whether the branch system 111 can or cannot prepare the payment card.

The application OL 105 may then select the most suitable branch location as a pickup location based on the responses provided by each branch system 111. For example, the application OL 105 may select a branch that can fulfill the request and is nearest to the delivery address. In some embodiments, the application OL 105 may compute a score for each branch, and select the branch having the highest score. Once a branch is selected, the application OL 105 may transmit a request to the APIs of one or more of the third party delivery services 104. The one or more third party delivery services 104 may correspond to those delivery services that are available to deliver the item at the time 204 specified by the user. The requests transmitted by the application OL 105 may specify one or more of: the delivery address, a pickup address corresponding to the selected branch, the pickup time, and/or any requirement for pickup and/or delivery of the item (e.g., mode of delivery, security requirements, etc.). The third party delivery services 104 may then transmit a respective response to the application OL 105. The response may generally indicate whether the delivery request can be fulfilled and at what cost.

The application OL 105 may then select one of the delivery services 104 that provide a response indicating that the delivery request can be fulfilled. For example, in embodiments, the application OL 105 selects the delivery service 104 based on the cost of delivery received from the third party APIs 110. However, the application OL 105 may additionally and/or alternatively select the delivery services 104 based on proximity to the selected branch, proximity to the delivery address, whether security requirements for the item and/or delivery can be fulfilled, on-time percentages indicating how often the delivery service makes timely deliveries, etc.

The application OL 105 may transmit a request to the selected delivery service 104 to deliver the item to the delivery address. Generally, the request may specify all relevant parameters of the order (e.g., pickup time, pickup location, item information, delivery address, security requirements, mode of delivery, the delivery time selected by the user, etc.). The selected delivery service 104 may then transmit an indication of acceptance of the request to the application OL 105. The indication of acceptance may include tracking information for the delivery service. The application OL 105 may then create a record for the order in the database 113. The record in the database 113 may specify all order details, including customer identifier, customer name, the delivery address, the delivery time, the pickup location (e.g., the selected branch), the pickup time, and/or the tracking information. The application OL 105 may further transmit instructions to the selected branch system 111 to prepare the ordered item (e.g., the payment card) for pickup by the specified pickup time. The branch systems 111 may then store the instructions in the branch data 112, which may trigger a workflow to allow the item to be prepared at the branch.

The application OL 105 may further transmit a confirmation to the client application 108. FIG. 2E is a schematic 240 illustrating an example order confirmation. While not depicted, the client application 108 may receive real-time updates regarding the order status from the application OL 105 (e.g., processing, prepared, picked up by delivery service, delivery transit status, delivered, etc.). For example, the application OL 105 may receive real-time updates from the selected delivery service 104 and transmit the received updates to the client application 108. The client application 108 may output the updates to the user for order tracking purposes. The updates may be outputted in text-based GUIs, map-based GUIs, and/or a combination thereof. Furthermore, as updates are received, the application OL 105 may store an indication of each update in the database 113.

In some embodiments, fraud detection systems may analyze the record for the order in the database 113. Doing so may allow the fraud detection systems to prevent fraudulent activity. For example, if 10 orders are received to deliver 10 replacement cards to 10 different addresses, the fraud detection systems may generate a fraud alert on the associated account. Furthermore, the fraud detection systems may cancel one or more of the orders to protect the account.

In some embodiments, the user of the client device 101 may pick up the ordered item at one of the branch locations. Generally, the address provided by the user may correspond to a location near which the user would like to pick up the ordered item. In such embodiments, the application OL 105 may determine the pickup time at the branch location based on a time at the branch location (and/or the address provided by the user), and not the time of the client device 101. In such embodiments, the application OL 105 need not communicate with any delivery services to orchestrate pickup and/or delivery of the ordered item.

As stated, the system 100 may provide any number of services 107 that may make any number of API calls based on integration of the services 107 and/or APIs 106, 109, 110. Once onboarded, the components of the system 100 may generally communicate according to defined request/response formats. Table I below depicts an example set of APIs that may be provided by the APIs 106, 109, 110.

TABLE I

| API Name | Description |
|---|---|
| /autocomplete | API 110 of third party services 104 may |
| | receive address input (e.g., field 202 of |
| | FIG. 2B) and return suggested addresses |
| | 203 to be autocompleted. In some |
| | embodiments, client device API 109 |
| | communicates directly with /autocomplete |
| | API via gateways 102, 103. In other |
| | embodiments, client device API 109 |
| | communicates with /autocomplete API via |
| | application OL 105 |
| /send-message | API 109 of client device to generate a |
| | formatted (e.g., JSON, XML, etc.) |
| | message (e.g., for orders, delivery |
| | addresses, etc.) |
| /services | API 106 of application OL 105. May |
| | return service availability results, e.g., |
| | service area availability, limits per |
| | customer, limits per product |
| /orders | API 106 of application OL 105. For |
| | persisting, updating, and/or deleting orders |
| | (e.g., in the database 113 and/or orders |
| | transmitted to branch systems 111 and/or |
| | third party services 104). |
| /deliveryenpdoints | API 110 of third party services 104 and/or |
| | API 106 of application OL 105. Returns |
| | endpoints for pickup and/or delivery. |
| /placesendpoints | API 110 of third party services 104 that |
| | returns one or more places near a specified |
| | address for pickup and/or delivery. |
| /samedayendpoints | API 110 of third party services 104 that |
| | returns areas and/or physical locations |
| | providing same-day delivery service. |
| /send-message | API 106 of application OL 105. May |
| | generate and send formatted orders (e.g., |
| | JSON, XML, etc.) |
| /deliveryavailability | API 110 of third party services 104 and/or |
| | API 106 of application OL 105. Returns an |
| | indication of whether delivery service is |
| | available at delivery address. |
| /createdelivery | API 110 of third party services 104 for |
| | creating deliveries (e.g., based on a |
| | formatted order). |
| /maps | API 110 of third party services 104- |
| | returns whether service is available at |
| | delivery address |
| /sent-message | API 106 of application OL 105. Transmits |
| | messages (e.g., SMS, email, etc.) to client |
| | and/or client application 108 |
| /eligibility | API 110 of third party services 104 and/or |
| | API 106 of application OL 105. For |
| | determining eligibility of onboarding |
| | users. |

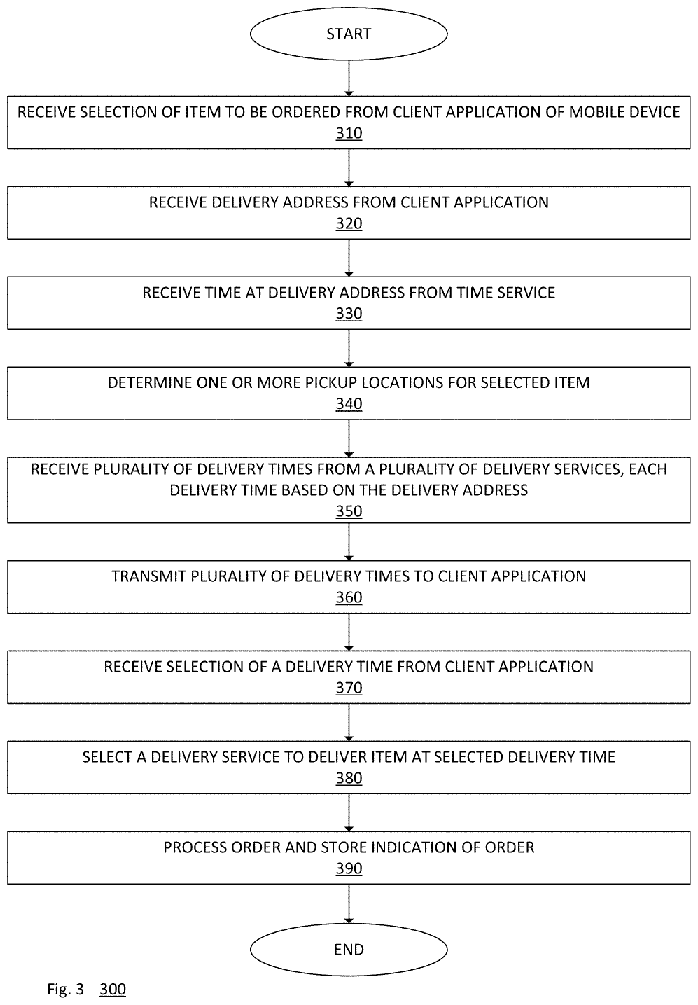

FIG. 3 illustrates an embodiment of a logic flow 300. The logic flow 300 may be representative of some or all of the operations executed by one or more embodiments described herein. For example, the logic flow 300 may include some or all of the operations performed to determine delivery times based on a delivery address for an order. Embodiments are not limited in this context.

As shown, the logic flow 300 begins at block 310, where the application OL 105 receives selection of an item to be ordered. The selection may be made by a user of a client device 101 via the client application 108. For example, the item to be ordered may be a payment card associated with an account at a financial institution. In one embodiment, an API 109 of the client application 108 transmits an indication of the selected item to be ordered via the gateways 102, 103. As stated, the user may generally authenticate into the client application 108 prior to selecting the item to be ordered. At block 320, the application OL 105 may receive a delivery address from the client application 108. The delivery address may correspond to the location where the selected item is to be delivered.

At block 330, the application OL 105 receives a current time at the delivery address from the network time service 114. For example, the application OL 105 may provide the delivery address received at block 320 to the network time service 114. The network time service 114 may return the current time at the delivery address. As stated, the application OL 105 and/or the network time service 114 may apply any offsets needed to determine the actual time at the delivery location. At block 340, the application OL 105 determines one or more pickup locations for the selected item. For example, a local branch of the financial institution nearest to the delivery address may be selected. As another example, a third party service 104 may return one or more pickup locations where the item may be picked up (e.g., a restaurant location for a food item selected by the customer).

At block 350, the application OL 105 may receive a plurality of delivery times from a plurality of delivery services. Each delivery time may be local to the delivery address. For example, a service 107 of the application OL 105 may make a call to an API 106 to provide the delivery address to the APIs 110 of the delivery services 104. The delivery services 104 may then return the available delivery times to the application OL 105. At block 360, the application OL 105 may transmit the available delivery times received at block 350 to the client application 108. The client application 108 may output the available delivery times to the user for selection. At block 370, the application OL 105 receives selection of a delivery time from the client application 108. Generally, the user may select one of the available delivery times, and the client application 108 may provide an indication of the selected delivery time to the application OL 105.

At block 380, the application OL 105 selects a delivery service to deliver the item at the delivery time selected by the user. In one embodiment, multiple delivery services may be able to deliver the item at the delivery time selected by the user. Therefore, the application OL 105 may select the delivery service based on any number of factors such as cost, the service's timeliness for prior deliveries, proximity to the pickup location and/or the delivery address, etc. If only one delivery service is able to deliver the item at the selected delivery time, the application OL 105 selects the available delivery service. At block 390, the application OL 105 processes the order and stores a record for the order in the database 113.

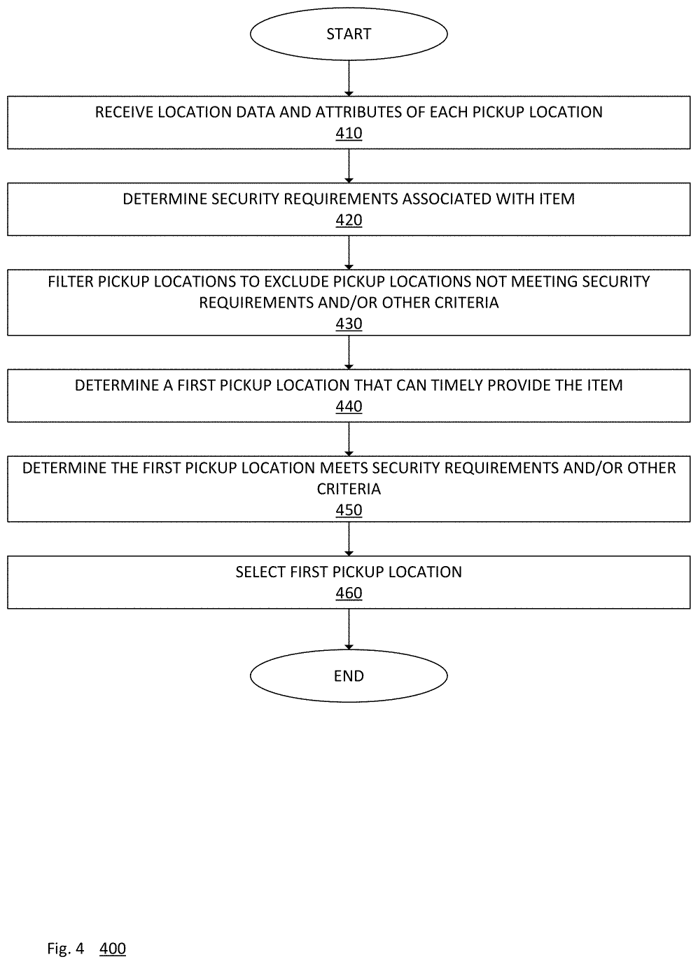

FIG. 4 illustrates an embodiment of a logic flow 400. The logic flow 400 may be representative of some or all of the operations executed by one or more embodiments described herein. For example, the logic flow 400 may include some or all of the operations to select a pickup location for an item to be delivered. Embodiments are not limited in this context.

As shown, the logic flow 400 begins at block 410, where the application OL 105 receives location data and attributes of each possible pickup location. For example, the third party services 104 and/or the branch systems 111 may return one or more possible pickup locations based on the delivery address and/or the item to be ordered. The location data may specify a respective address of each pickup location. The attributes of each possible pickup location may include any type of attribute, such as what services are offered, products offered, whether the location can fulfill security requirements (e.g., provide secure packaging, etc.), staff availability, a time the item may be available, a cost of preparing the item, etc.

At block 420, the application OL 105 determines security requirements associated with the item. For example, the security requirements may specify that the item needs to be in secure packaging. At block 430, the application OL 105 may filter the pickup locations to exclude pickup locations not meeting security requirements. For example, if a retail branch of a financial institution does not have secure packaging for the payment card, the application OL 105 may exclude this branch from further consideration. At block 440, the application OL 105 determines that a first pickup location can timely provide the item for pickup by the delivery service. For example, if the pickup time is 4:00 PM, the application OL 105 may receive data from the branch system 111 for the first pickup location indicating that the payment card will be ready for pickup by 3:00 PM. Therefore, the application OL 105 may determine that the first pickup location can timely provide the payment card.

At block 450, the application OL 105 determines that the first pickup location meets the security requirements and/or any other criteria. For example, the application OL 105 may receive data from the branch system 111 for the first pickup location indicating that the first pickup location has the required secure packaging for the payment card. More generally, the data received from the branch system 111 for the first pickup location may be processed by the application OL 105 to determine that all criteria for preparing, pickup, and/or delivery of the item to the delivery address can be fulfilled by selecting the first pickup location to prepare the item. At block 460, the application OL 105 selects the first location.

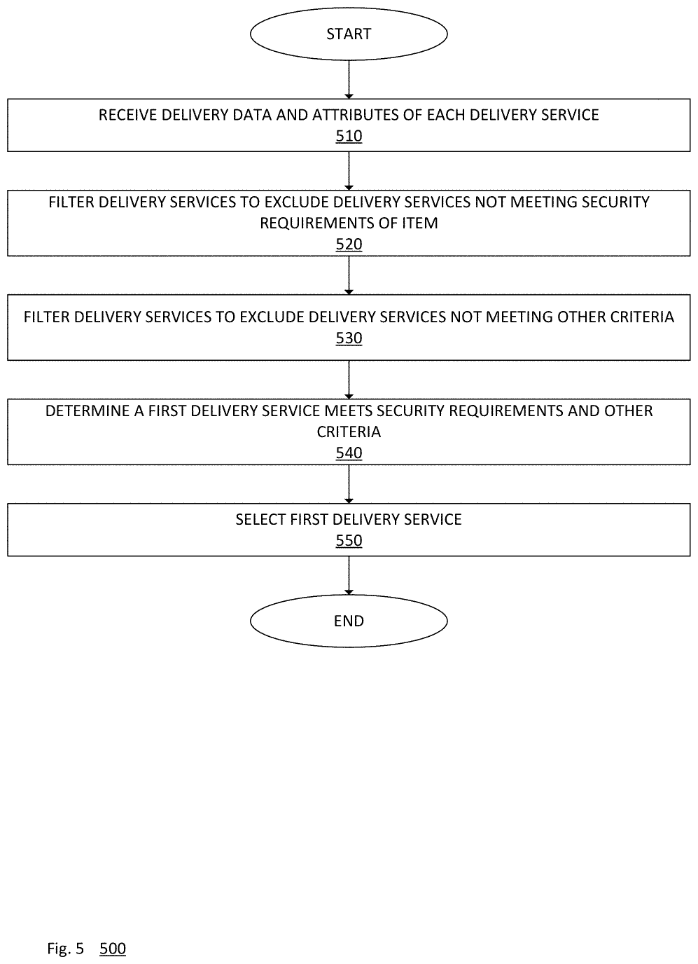

FIG. 5 illustrates an embodiment of a logic flow 500. The logic flow 500 may be representative of some or all of the operations executed by one or more embodiments described herein. For example, the logic flow 500 may include some or all of the operations performed to select a delivery service. Embodiments are not limited in this context.

As shown, the logic flow 500 begins at block 510, where the application OL 105 receives delivery data and attributes of each possible delivery service. For example, the third party services 104 may return one or more available delivery times and a cost of delivering the item to the delivery address at each available delivery time. The attributes of each possible delivery service may include any type of attribute, such as what modes of delivery are offered (e.g., bike, automobile, armored truck), whether the delivery service can fulfill security requirements (e.g., provide secure packaging, collect signatures, etc.), etc.

At block 520, the application OL 105 may filter the delivery services to exclude delivery services not meeting security requirements. For example, if a delivery service does not have the required secure packaging for the payment card, the application OL 105 may exclude this delivery service from further consideration. At block 530, the application OL 105 may filter the delivery services to exclude delivery services not meeting other criteria. For example, if a cost attribute received from a delivery service for delivering the item exceeds a cost threshold, the application OL 105 may exclude the delivery service from further consideration.

At block 540, the application OL 105 determines that a first delivery service meets the security requirements and/or any other criteria. For example, the application OL 105 may receive data from the third party service 104 for the first delivery service indicating that the first delivery service can timely deliver the item to the delivery address at a cost that is below the cost threshold. At block 550, the application OL 105 selects the first delivery service.

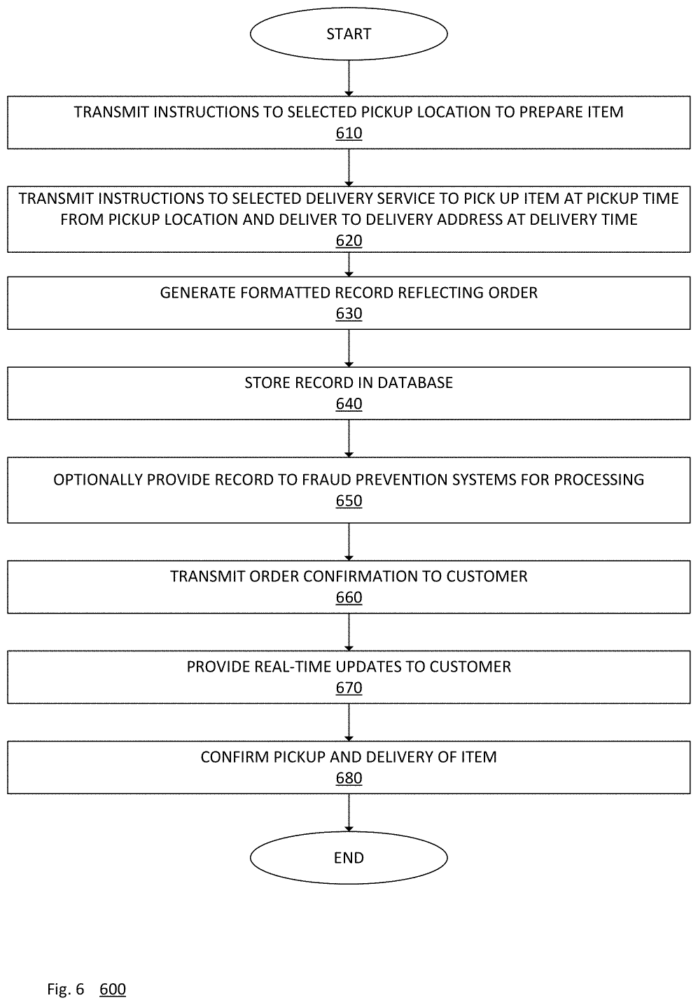

FIG. 6 illustrates an embodiment of a logic flow 600. The logic flow 600 may be representative of some or all of the operations executed by one or more embodiments described herein. For example, the logic flow 600 may include some or all of the operations performed to process an order. Embodiments are not limited in this context.

As shown, the logic flow 600 begins at block 610, where the application OL 105 transmits instructions to the selected pickup location to prepare the item for pickup. A service 107 of the application OL 105 may generate a formatted set of instructions and transmit the instructions via one or more APIs 106. For example, the application OL 105 may transmit instructions to a branch of a financial institution to prepare a payment card for a customer account. The instructions may further include any additional details such as pickup time, a tracking number provided by the delivery service, customer information, delivery address, etc. At block 620, the application OL 105 transmits instructions to the selected delivery service to pick up the item at the pickup location and deliver to the delivery address at the selected delivery time. A service 107 of the application OL 105 may generate a formatted set of instructions and transmit the instructions via one or more APIs 106 to the APIs 110 of the selected delivery service. The instructions may indicate the ordered item, the delivery address, the customer name, the pickup location, any security requirements, and any other required attribute.

At block 630, a service 107 of the application OL 105 may generate a formatted purchase order record reflecting attributes of the order. The attributes may include the item/service ordered, the pickup location, the associated customer account, the delivery service, the delivery time, and any other attribute. At block 640, the record is stored in the database 113. At block 650, the record is optionally provided to fraud detection systems for processing. Doing so allows the fraud detection services to determine whether the order is fraudulent, or indicative of fraudulent activity. At block 660, the application OL 105 transmits an order confirmation to the customer. The order confirmation may be, for example and without limitation, sent to the client application 108, sent via email to the customer, sent as a text message, or sent via any computer-based communications method. At block 670, the client application 108 may output real-time updates received from the application OL 105 regarding the status of the order. At block 680, the application OL 105 receives confirmations (e.g., from the delivery service) indicating that the item has been picked up and delivered. The application OL 105 may store the confirmations with the associated record in the database 113.

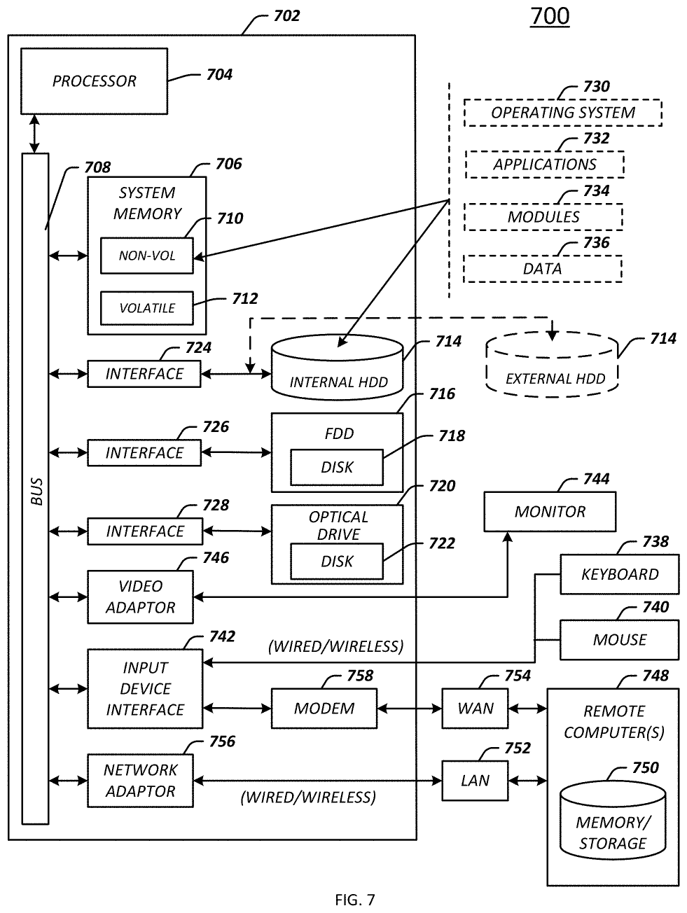

FIG. 7 illustrates an embodiment of an exemplary computing architecture 700 comprising a computing system 702 that may be suitable for implementing various embodiments as previously described. In various embodiments, the computing architecture 700 may comprise or be implemented as part of an electronic device. In some embodiments, the computing architecture 700 may be representative, for example, of a system that implements one or more components of the system 100. In some embodiments, computing system 702 may be representative, for example, of the client devices 101, gateway 102, gateway 103, third party services 104, application OL 105, branch systems 111, and network time service 114 of the system 100. The embodiments are not limited in this context. More generally, the computing architecture 700 is configured to implement all logic, applications, systems, methods, apparatuses, and functionality described herein with reference to FIGS. 1-6.

As used in this application, the terms “system” and “component” and “module” are intended to refer to a computer-related entity, either hardware, a combination of hardware and software, software, or software in execution, examples of which are provided by the exemplary computing architecture 700. For example, a component can be, but is not limited to being, a process running on a computer processor, a computer processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing system 702 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing system 702.

As shown in FIG. 7, the computing system 702 comprises a processor 704, a system memory 706 and a system bus 708. The processor 704 can be any of various commercially available computer processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core®, Core (2) Duo®, Itanium®, Pentium®, Xeon®, and XScale® processors; and similar processors. Dual microprocessors, multi-core processors, and other multi processor architectures may also be employed as the processor 704.

The system bus 708 provides an interface for system components including, but not limited to, the system memory 706 to the processor 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computing system 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies. The computing system 702 is generally is configured to implement all logic, systems, methods, apparatuses, and functionality described herein with reference to FIGS. 1-6.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. In one embodiment, the one or more application programs 732, other program modules 734, and program data 736 can include, for example, the various applications and/or components of the system 100, e.g., the client application 108, gateway 102, gateway 103, third party services 104, application OL 105, APIs 106, services 107, APIs 109, APIs 110, branch systems 111, branch data 112, database 113, and network time service 114.

A user can enter commands and information into the computing system 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processor 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. The monitor 744 may be internal or external to the computing system 702. In addition to the monitor 744, a computer typically includes other peripheral output devices, such as speakers, printers, and so forth.

The computing system 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computing system 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computing system 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computing system 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computing system 702, or portions thereof, can be stored in the remote memory/storage device 750. It will be appreciated that the network connections shown are exemplary and other means of establishing a communications link between the computers can be used.

The computing system 702 is operable to communicate with wired and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. A method, comprising:
receiving a request from an application executing on a mobile device specifying a delivery address for delivery of a payment card;
receiving a plurality of delivery times for delivery of the payment card from a plurality of delivery services, the plurality of delivery times based on a time at the delivery address, a time zone and the time at the delivery address different than a time zone and a time of the mobile device, respectively;
transmitting the plurality of delivery times for the delivery to the application executing on the mobile device;
receiving, from the application executing on the mobile device, selection of a first delivery time of the plurality of delivery times for delivery of the payment card;
determining, based on the delivery address and the first delivery time, a pickup location and a pickup time for the payment card;
transmitting, to a device associated with the pickup location, an indication specifying to prepare the payment card before the pickup time;
receiving, from the device associated with the pickup location, confirmation that the payment card will be prepared and available for pickup at the pickup location at the pickup time;
transmitting, to a first delivery service of the plurality of delivery services, a request to deliver the payment card to the delivery address, the request further specifying the pickup location and the pickup time for the payment card, the first delivery service associated with the selected first delivery time;
receiving, from the first delivery service, acceptance of the request to deliver the payment card to the delivery address;
transmitting, to the application executing on the mobile device, a confirmation indicating that the payment card was ordered for delivery to the delivery address by the first delivery service at the first delivery time;
storing, in a database, an indication that the payment card was ordered for delivery to the delivery address by the first delivery service at the first delivery time, the stored indication further specifying an account associated with the mobile device;
receiving, from the device associated with the pickup location, a first indication specifying the payment card has been prepared;
receiving, from the first delivery service, a second indication specifying the payment card has been picked up; and
receiving, from the first delivery service, a third indication specifying the payment card has been delivered to the delivery address.

2. The method of claim 1, further comprising:
transmitting, to the application executing on the mobile device, an indication that the plurality of delivery times are based on the time at the delivery address and not the time of the mobile device.

3. The method of claim 1, further comprising:
receiving, from the mobile device, input in an address field specifying a portion of the delivery address;
transmitting the received portion of the delivery address to an address autocomplete application programming interface (API);
receiving, by the mobile device from the address autocomplete API, the delivery address; and
transmitting the delivery address to the application executing on the mobile device, the application executing on the mobile device to autocomplete the delivery address in the address field.

4. The method of claim 1, further comprising:
providing the delivery address to an application programming interface (API) of a clock microservice;
receiving the time for the delivery address of the from the API of the clock microservice; and
storing, in the database, the first indication, the second indication, and the third indication.

5. The method of claim 4, further comprising:
determining the time zone associated with the delivery address; and
applying an offset to the received time for the delivery address to determine the time at the delivery address, the offset based on the time zone associated with the delivery address.

6. The method of claim 5, wherein the pickup location is one of a plurality of pickup locations, wherein the plurality of pickup locations comprise branches of a financial institution issuing the payment card.

7. The method of claim 1, further comprising:
determining a security requirement associated with the payment card, the security requirement comprising one or more of: (i) a required mode of delivery for the payment card, (ii) a required packaging for the payment card, or (iii) a proof of identification required for delivering the payment card;
selecting the pickup location from a plurality of pickup locations based on a determination that the pickup location can fulfill the security requirement associated with the payment card;
selecting the first delivery service based on a determination that the first delivery service can fulfill the security requirement associated with the payment card;
analyzing the database to identify a plurality of other orders for payment cards associated with the account;
generating, based on the analysis, a fraud alert on the account; and
cancelling the order for the payment card based on fraud alert prior to delivery of the payment card to the delivery address.

8. A non-transitory computer-readable medium storing instructions which when executed by a processor cause the processor to:
receive a request from an application executing on a mobile device specifying a delivery address for delivery of a payment card;
receive a plurality of delivery times for delivery of the payment card from a plurality of delivery services, the plurality of delivery times based on a time at the delivery address, a time zone and the time at the delivery address different than a time zone and a time of the mobile device, respectively;
transmit the plurality of delivery times for the delivery to the application executing on the mobile device;
receive, from the application executing on the mobile device, selection of a first delivery time of the plurality of delivery times for delivery of the payment card;
determine, based on the delivery address and the first delivery time, a pickup location and a pickup time for the payment card;
transmit, to a device associated with the pickup location, an indication specifying to prepare the payment card before the pickup time;
receive, from the device associated with the pickup location, confirmation that the payment card will be prepared and available for pickup at the pickup location at the pickup time;
transmit, to a first delivery service of the plurality of delivery services, a request to deliver the payment card to the delivery address, the request further specifying the pickup location and the pickup time for the payment card, the first delivery service associated with the selected first delivery time;
receive, from the first delivery service, acceptance of the request to deliver the payment card to the delivery address;
transmit, to the application executing on the mobile device, a confirmation indicating that the payment card was ordered for delivery to the delivery address by the first delivery service at the first delivery time;
store, in a database, an indication that the payment card was ordered for delivery to the delivery address by the first delivery service at the first delivery time, the stored indication further specifying an account associated with the mobile device, the stored indication formatted according to a format;
receive, from the device associated with the pickup location, a first indication specifying the payment card has been prepared;
receive, from the first delivery service, a second indication specifying the payment card has been picked up; and
receive, from the first delivery service, a third indication specifying the payment card has been delivered to the delivery address.

9. The non-transitory computer-readable medium of claim 8, storing instructions which when executed by the processor cause the processor to:
transmit, to the application executing on the mobile device, an indication that the plurality of delivery times are based on the time at the delivery address and not the time of the mobile device.

10. The non-transitory computer-readable medium of claim 8, storing instructions which when executed by the processor cause the processor to:
receive, from the mobile device, input in an address field specifying a portion of the delivery address;
transmit the received portion of the delivery address to an address autocomplete application programming interface (API);
receive, by the mobile device from the address autocomplete API, the delivery address; and
transmit the delivery address to the application executing on the mobile device to provide the delivery address to the address field.

11. The non-transitory computer-readable medium of claim 8, storing instructions which when executed by the processor cause the processor to:
provide the delivery address to an application programming interface (API) of a clock microservice; and
receive the time at the delivery address of the from the API of the clock microservice.

12. The non-transitory computer-readable medium of claim 8, storing instructions which when executed by the processor cause the processor to:
determine a security requirement associated with the payment card, the security requirement comprising one or more of: (i) a required mode of delivery for the payment card, (ii) a required packaging for the payment card, or (iii) a proof of identification required for delivering the payment card;
receive an attribute of the first delivery service; and
receive an attribute of the pickup location.

13. The non-transitory computer-readable medium of claim 12, storing instructions which when executed by the processor cause the processor to:
determine, based on the attribute of the pickup location, that the pickup location can fulfill the security requirement associated with the payment card;
determine, based on the attribute of the first delivery service, that the first delivery service can fulfill the security requirement associated with the payment card;
select the pickup location from a plurality of pickup locations based on the determination that the pickup location can fulfill the security requirement associated with the payment card; and
select the first delivery service based on the determination that the first delivery service can fulfill the security requirement associated with the payment card.

14. The non-transitory computer-readable medium of claim 12,
storing instructions which when executed by the processor cause the processor to:
receive an attribute of a second delivery service of a plurality of delivery services;
receive an attribute of a second pickup location of a plurality of pickup locations;
determine, based on the attribute of the second pickup location, that the second pickup location cannot fulfill the security requirement associated with the payment card;
determine, based on the attribute of the second delivery service, that the second delivery service cannot fulfill the security requirement associated with the payment card;
eliminate the second delivery service as a candidate delivery service for delivering the payment card based on the determination the second delivery service cannot fulfill the security requirement associated with the payment card; and
eliminate the second pickup location as a candidate pickup location for the payment card based on the determination the second pickup location cannot fulfill the security requirement associated with the payment card.

15. A system, comprising:
a processor; and
a memory storing instructions which when executed by the processor cause the processor to:
receive a request from an application executing on a mobile device specifying a delivery address for delivery of a payment card;
receive a plurality of delivery times for delivery of the payment card from a plurality of delivery services, the plurality of delivery times based on a time at the delivery address, a time zone and the time at the delivery address different than a time zone and a time of the mobile device, respectively;
transmit the plurality of delivery times for the delivery to the application executing on the mobile device;
receive, from the application executing on the mobile device, selection of a first delivery time of the plurality of delivery times for delivery of the payment card;
determine, based on the delivery address and the first delivery time, a pickup location and a pickup time for the payment card;
transmit, to a device associated with the pickup location, an indication specifying to prepare the payment card before the pickup time;
receive, from the device associated with the pickup location, confirmation that the payment card will be prepared and available for pickup at the pickup location at the pickup time;
transmit, to a first delivery service of the plurality of delivery services, a request to deliver the payment card to the delivery address, the request further specifying the pickup location and the pickup time for the payment card, the first delivery service associated with the selected first delivery time;
receive, from the first delivery service, acceptance of the request to deliver the payment card to the delivery address;
transmit, to the application executing on the mobile device, a confirmation indicating that the payment card was ordered for delivery to the delivery address by the first delivery service at the first delivery time;
store, in a database, an indication that the payment card was ordered for delivery to the delivery address by the first delivery service at the first delivery time;
receive, from the device associated with the pickup location, a first indication specifying the payment card has been prepared;
receive, from the first delivery service, a second indication specifying the payment card has been picked up; and
receive, from the first delivery service, a third indication specifying the payment card has been delivered to the delivery address.

16. The system of claim 15, the memory storing instructions which when executed by the processor cause the processor to:
transmit, to the application executing on the mobile device, an indication that the plurality of delivery times are based on the time at the delivery address and not the time of the mobile device.

17. The system of claim 15, the memory storing instructions which when executed by the processor cause the processor to:
receive, from the mobile device, input in an address field specifying a portion of the delivery address;
transmit the received portion of the delivery address to an address autocomplete application programming interface (API);
receive, by the mobile device from the address autocomplete API, the delivery address; and
transmit the delivery address to the application executing on the mobile device to provide the delivery address to the address field.

18. The system of claim 15, the memory storing instructions which when executed by the processor cause the processor to:
provide the delivery address to an application programming interface (API) of a clock microservice;
receive the time for the delivery address of the from the API of the clock microservice.
determine the time zone associated with the delivery address; and
apply an offset to the received time for the delivery address to determine the time at the delivery address, the offset based on the time zone associated with the delivery address.

19. The system of claim 15, the memory storing instructions which when executed by the processor cause the processor to:
determine a security requirement associated with the payment card, the security requirement comprising one or more of: (i) a required mode of delivery for the payment card, (ii) a required packaging for the payment card, or (iii) a proof of identification required for delivering the payment card;
receive an attribute of the first delivery service; and
receive an attribute of the pickup location.

20. The system of claim 19, the memory storing instructions which when executed by the processor cause the processor to:
determine, based on the attribute of the pickup location, that the pickup location can fulfill the security requirement associated with the payment card;
determine, based on the attribute of the first delivery service, that the first delivery service can fulfill the security requirement associated with the payment card;
select the pickup location from a plurality of pickup locations based on the determination that the pickup location can fulfill the security requirement associated with the payment card; and
select the first delivery service based on the determination that the first delivery service can fulfill the security requirement associated with the payment card.
